(19) United States
(12) Patent Application Publication
(10) Pub. No.: US 2008/0136902 A1
(43) Pub. Date: Jun. 12, 2008

(54) PORTABLE VIDEO/AUDIO DEVICE

(76) Inventors: Jung-Chang WU, Taipei (TW); Wei-Yu Wu, Taipei (TW)

Correspondence Address: Lowe Hauptman & Berner, LLP, Suite 300, 1700 Diagonal Rd., Alexandria, VA, 22314, US

(21) Appl. No.: 11/567,412

(22) Filed: Dec. 6, 2006

(51) Int. Cl. H04N 7/18

(52) U.S. Cl. 348/61; 348/E07.085

(57) ABSTRACT

A portable video/audio device that is mainly composed of a portable video/audio player and N (Our RD could not understand what is “N”? please check.) connection bases, wherein the connection bases can be disposed at any place and any position. The connection base is configured with a receiving for receiving the portable video/audio player. A connection port is set on the receiving recess so as to connect with a connection groove on the back of the portable video/audio player. Accordingly, in any place with a connection base, the user can connect the portable video/audio player with the connection base to enable the portable video/audio player.

### FIELD OF THE INVENTION

The present invention relates a portable video/audio device, and in particular, to a portable video/audio device that connects with a socket disposed in any place.

### DESCRIPTION OF THE PRIOR ART

Recently, it is gradually found that video/audio devices are disposed on mass transportation to provide passengers with entertainment and to create profit by advertisements on the video/audio devices. However, such video/audio devices are not originally disposed in mass transportation but vehicles but extra equipments of vehicles. The video/audio devices are generally disposed on the back of the front seat of the car so that the passenger at back seat could enjoy the video/audio programs. Moreover, certain video/audio devices could be used as a games console. Such video/audio devices are popular due to the prevalence of traveling in the past few years. However, the video/audio devices are mounted to the back of the front seat of the car or general mass transportation, and a receiving recess is further disposed on the back of the front seat of the car to receive the video/audio device. Although this manner can fix the video/audio devices on a desired position, nonetheless, these video/audio devices cannot meet the requirement of convenience for the consumer.

Accordingly, the above-described prior art product is not a perfect design and has still many disadvantages to be solved

The inventor has noticed the various disadvantages associated with the conventional video/audio devices and thought to improve it. After having carried out an intensive study for many years, he has successfully developed the video/audio device of the present invention.

### SUMMARY OF THE INVENTION

An object of the invention is to provide a portable video/audio device that can be connected to a socket disposed in any place.

Another object of the invention is to provide a portable video/audio device for fast disconnection or connection.

To achieve the above purposes, the present invention provides a portable video/audio device. A connection base is disposed at a place where the portable video/audio device is frequently used by the user and a connection groove is disposed at the back of the portable video/audio device to connect with a connection port on the connection base so that the user could employ as desired at any place where a portable video/audio device is disposed.

### BRIEF DESCRIPTION OF THE DRAWINGS

The drawings disclose an illustrative embodiment of the present invention which serves to exemplify the various advantages and objects hereof, and are as follows:

FIG. 1 is a three-dimensional explosion diagram of a portable video/audio device and a connection base of the present invention;

FIG. 2 is a three-dimensional diagram of the rear side of a portable video/audio device of the present invention;

FIG. 3 is a diagram that shows a portable video/audio device and a connection base disposed on the back of a seat of the present invention;

FIG. 4 is a diagram that shows a portable video/audio device and a connection base disposed on a pillow of a seat of the present invention;

FIG. 5 is a diagram that shows a portable video/audio device and a connection base disposed on an armrest of a seat of the present invention;

FIG. 6 is a diagram that shows a portable video/audio device and a connection base disposed on a wall of the present invention;

FIG. 7 is a diagram that shows a portable video/audio device and a connection base, which is a hand-held mobile device, of the present invention; and

FIG. 8 is a diagram that shows a portable video/audio device and a connection base to which an angle regulating structure is disposed of the present invention.

### DETAILED DESCRIPTION OF THE PREFERRED EMBODIMENT

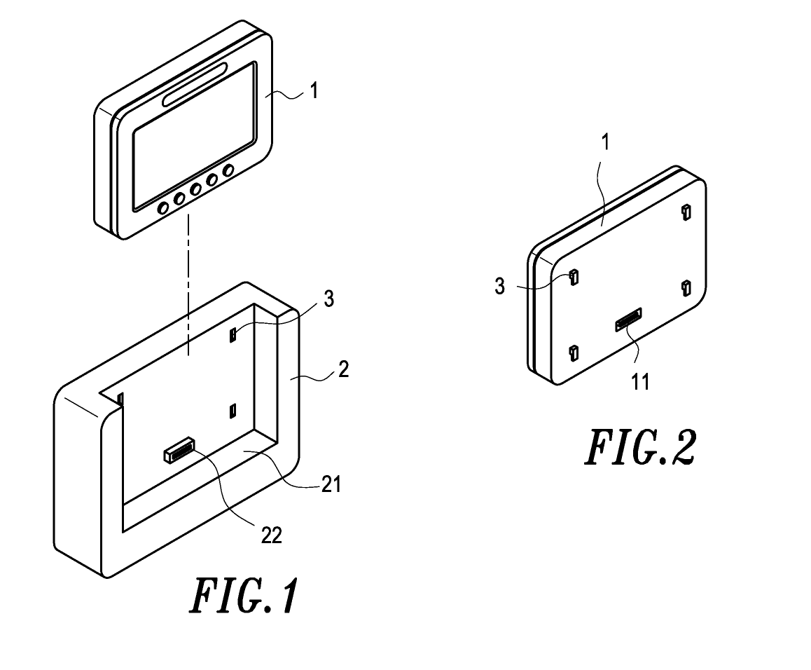

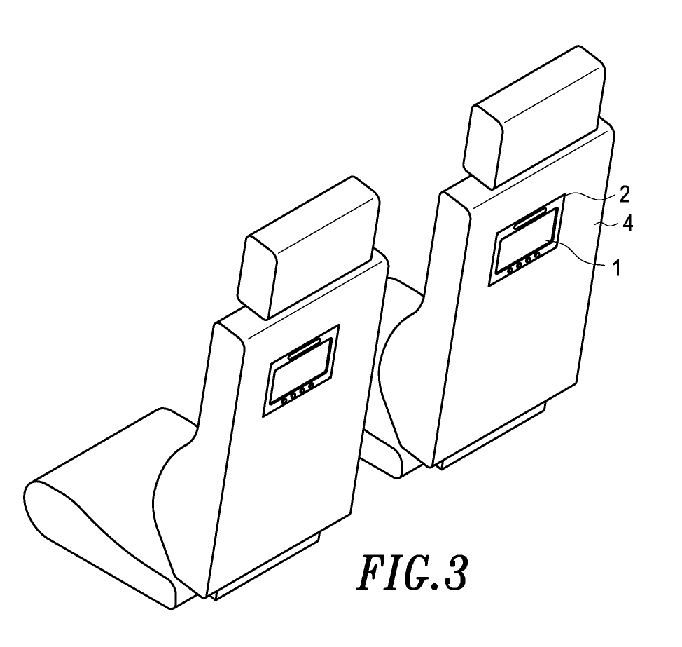

Referring to FIGS. 1 and 2, which show a portable video/audio device provided by the present invention, the portable video/audio device comprises:

A portable video/audio player 1 having thereon a screen for displaying image and an operation button for controlling video/audio play. Besides, the backside of the portable video/audio player 1 is configured with a connection groove 11; N (Our RD could not understand what is “N”? please check.) connection bases 2, each is configured with a receiving recess 21 for receiving the video/audio player 1, and the receiving recess 21 is configured with a connection port 22 for connecting with the connection groove 11 on the backside of the portable video/audio player 1.

The operation of the portable video/audio device of the present invention is achieved under the following process: the portable video/audio player 1 is received by the receiving recess 21 of the connection base 2, and the connection groove 11 on the backside of the portable video/audio player 1 connects with the connection port 22 of the connection base 2. Unlike the conventional portable video/audio device that can only be used in a single place, the user may take the portable video/audio player 1 and just finds a place with a connection base 2 to use the portable video/audio player 1. Moreover, the connection groove 11 on the backside of the portable video/audio player 1 and the connection port 22 of the connection base 2 are used for the combination of the portable video/audio player 1 and the connection base 2, and therefore, the position of the connection groove 11 and the position of the connection port 22 can be exchanged with each other, i.e. the connection port 22 be disposed on the backside of the portable video/audio player 1, and the connection groove 11 be disposed on the connection base 2. Further, two fixing members 3, which can be engaged with each other, are respectively disposed on the backside of the portable video/audio player 1 and the connection base 2 so that the portable video/audio player 1 is firmly connected with the connection base 2. The fixing members 3 are fixing components that can be dismantled rapidly, such as pivot members or touch fasteners.

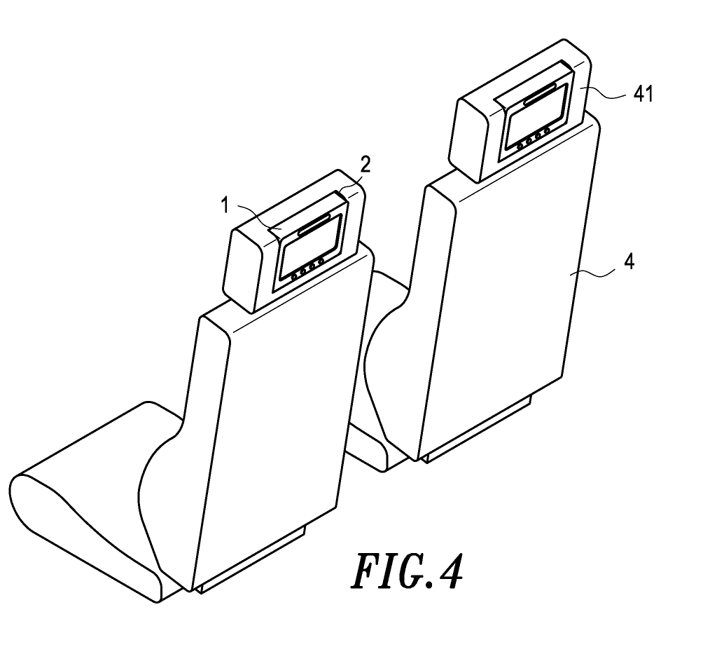

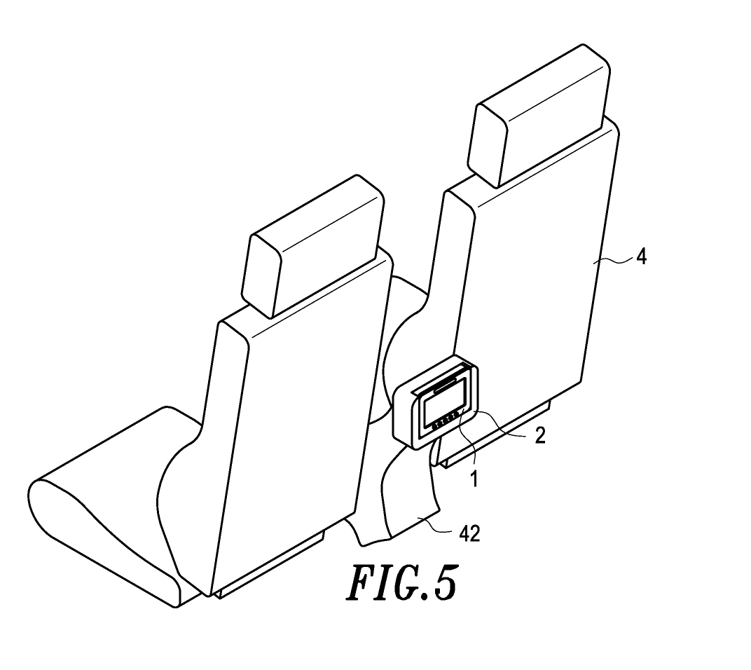

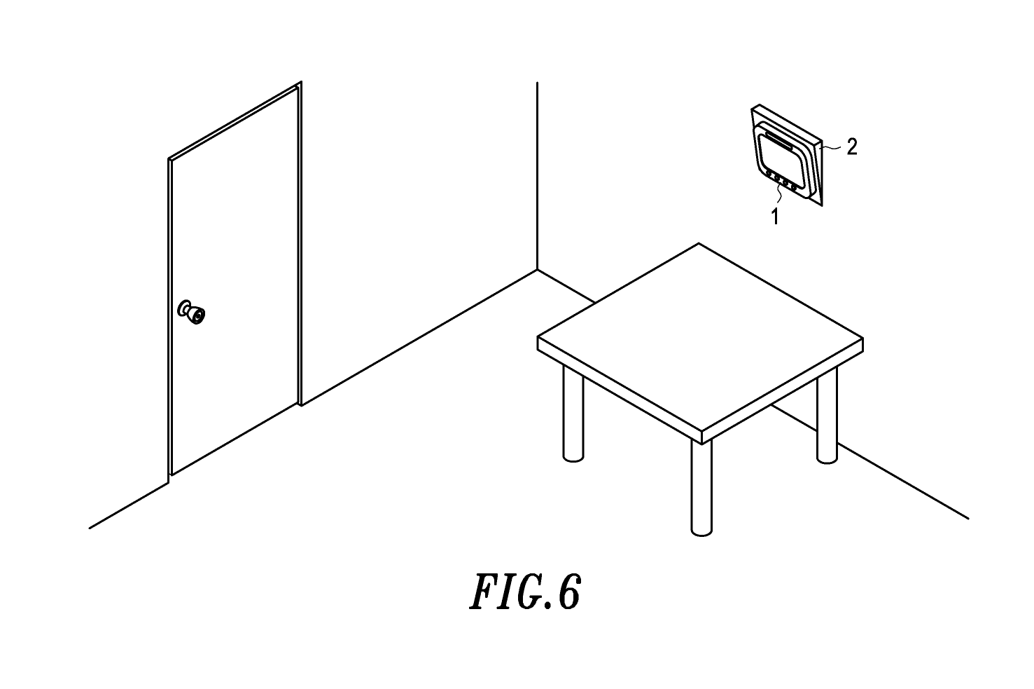

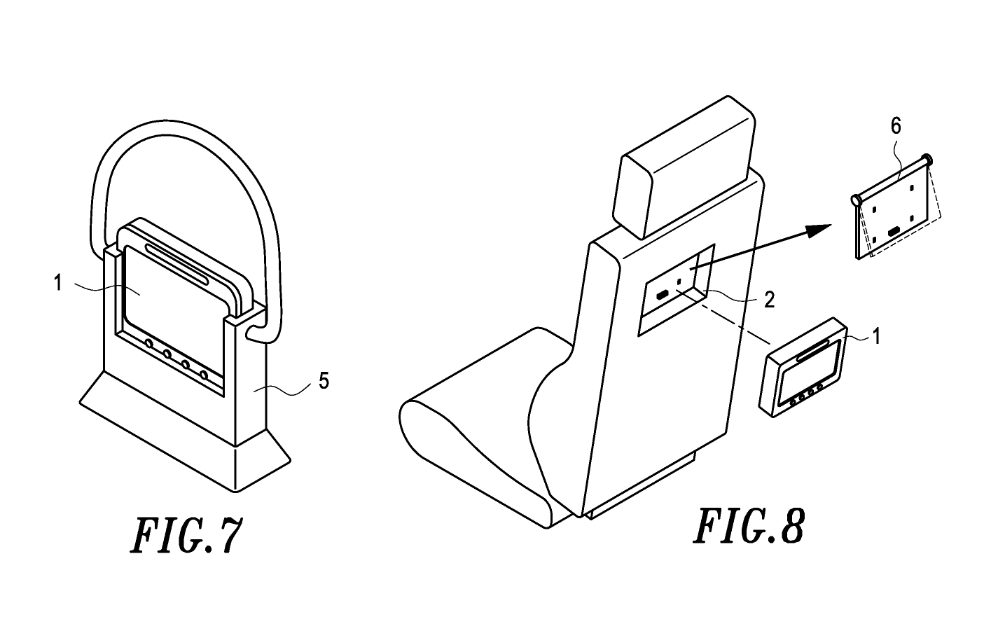

Referring to FIGS. 3-6, in the portable video/audio device of the present invention, the connection base 2 can be disposed on the back of the seats 4 on the transportation, such as cars, airplanes, vessels, on pillow 41 of the seat 4, on armrest 42 of the seat 4 or the dome of cars, airplanes, vessels. The connection base 2 may also be disposed on the wall of houses, offices, or coffee shops. Moreover, the connection base 2 is a hand-held mobile device 5 (referring to FIG. 7). That is to say, the connection base 2 can be disposed in any place such that the user can use the portable video/audio player 1 in the place where the connection base is disposed.

Further, referring to FIG. 8, the connection base 2 of the portable video/audio device provided by the present invention is configured with an angle regulating structure 6 so that the users with different heights can adjust the portable video/audio player 1 to a proper watching position.

The above description is an exemplary embodiment of the present invention, nevertheless, the embodiment does not limit the scope of the claimed invention. Any equivalent application or change falls within the scope of the present invention should be incorporated in the claims of the present invention.

Given the above, the present invention has novelty in spatial type, and has many advantages over the conventional products. Therefore, the present invention does have novelty and inventiveness required by the Patent Law. It is respectfully requested for patenting the present invention.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A portable video/audio device, particularly a connection base disposed at any place for connecting to a portable video/audio player, characterized in that: the back of the portable video/audio device being disposed with a connection groove to connect with a connection port on the connection base so that the portable video/audio player can rapidly connect or disconnect to/from the connection base.

2. A portable video/audio device, particularly a connection base disposed at any place for connecting to a portable video/audio player, characterized in that: the back of the portable video/audio device being disposed with a connection port to connect with a connection groove on the connection base so that the portable video/audio player can rapidly connect or disconnect to/from the connection base.

3. The portable video/audio device of claim 1, wherein two fixing members, which can be engaged with each other, are respectively disposed on the back of the portable video/audio player and the connection base so that the portable video/audio player is firmly connected with the connection base.

4. The portable video/audio device of claim 1, wherein the connection base is disposed on a pillow of a seat of a car, an airplane or a vessel.

5. The portable video/audio device of claim 1, wherein the connection base is disposed on the back of a seat of a car, an airplane or a vessel.

6. The portable video/audio device of claim 1, wherein the connection base is disposed on an armrest of a seat of a car, an airplane or a vessel.

7. The portable video/audio device of claim 1, wherein the connection base is disposed on the dome of a car, an airplane or a vessel.

8. The portable video/audio device of claim 1, wherein the connection base is disposed on a wall.

9. The portable video/audio device of claim 1, wherein the connection base is a hand-held mobile device.

10. The portable video/audio device of claim 1, wherein an angle regulating structure is disposed on the connection base so that the user can regulate the portable video/audio player to an appropriate angle for watching.

11. The portable video/audio device of claim 2, wherein two fixing members, which can be engaged with each other, are respectively disposed on the back of the portable video/audio player and the connection base so that the portable video/audio player is firmly connected with the connection base.

12. The portable video/audio device of claim 2, wherein the connection base is disposed on a pillow of a seat of a car, an airplane or a vessel.

13. The portable video/audio device of claim 2, wherein the connection base is disposed on the back of a seat of a car, an airplane or a vessel.

14. The portable video/audio device of claim 2, wherein the connection base is disposed on an armrest of a seat of a car, an airplane or a vessel.

15. The portable video/audio device of claim 2, wherein the connection base is disposed on the dome of a car, an airplane or a vessel.

16. The portable video/audio device of claim 2, wherein the connection base is disposed on a wall.

17. The portable video/audio device of claim 2, wherein the connection base is a hand-held mobile device.

18. The portable video/audio device of claim 2, wherein an angle regulating structure is disposed on the connection base so that the user can regulate the portable video/audio player to an appropriate angle for watching.
